(19) United States
(12) Patent Application Publication
(10) Pub. No.: US 2013/0025140 A1
(43) Pub. Date: Jan. 31, 2013

(54) PORTABLE PANEL CUTTER

(71) Applicant: Sang Jo Sim, Goyang-si (KR)

(72) Inventor: Sang Jo Sim, Goyang-si (KR)

(21) Appl. No.: 13/638,931

(22) PCT Filed: Mar. 28, 2011
(86) PCT No.: PCT/KR11/02101

§ 371 Date: Oct. 1, 2012

(30) Foreign Application Priority Data
Mar. 29, 2010 (KR) 10-2010-0027636

(51) Int. Cl. B26D 3/00

(52) U.S. Cl. 30/278

(57) ABSTRACT

The present invention relates to a portable panel cutter for cutting and tailoring a plate material such as a sandwich panel which is formed by overlapping a metal plate material at both side surfaces of an insulating material. The portable panel cutter includes: a cutting blade (10); a pulling means (20) for pulling the cutting blade; and a driving means (60) for driving the pulling means (20). The cutting blade is additionally provided with a cutting blade section (14), which is detachably coupled with the cutting blade. Therefore, it is possible to repair or partially substitute the cutting blade section in the case of the abrasion or breakage of the cutting blade section, thereby maximizing economic and cutting efficiencies. In addition, a general purpose drill is mounted and used as the driving means instead of a motor, thereby exhibiting superior portability.

### FIELD OF THE INVENTION

The present invention relates to a portable panel cutter for cutting and tailoring a plate material such as a sandwich panel formed by overlapping a metal plate material at both side surfaces of a heat insulating material such as panel for building, i.e., styrofoam, urethane foam or glass wool and the like in construction site, more particularly, a portable panel cutter which is more conveniently portable as a general-purpose electric drill mounted to a speed reducer is used instead of a motor as a driving means and also enables a cutting blade section to be repaired and partially replaced for its re-use at the time of wear or damage of the cutting blade section, thereby maximizing economical efficiency and cutting efficiency as the cutting blade section of cutting blade for cutting the metal plate material is separately provided and detachably used.

### DESCRIPTION OF RELATED ART

In general, used in the construction site is a cutter for cutting and tailoring the plate material such as the sandwich panel formed by overlapping the metal plate material at both side surfaces of the heat insulating material such as panel for building, i.e., styrofoam, urethane foam or glass wool and the like.

As illustrated in Korean Utility Model Registration No. 20-323362 titled “electric sandwich panel cutter of blade type”, the above-mentioned cutter comprises a pair of upper and lower circular plate-type blades, a driving motor for rotationally driving the upper and lower circular plate-type blades, a moving means for moving the driving motor, and controller for controlling the rotation of the upper and lower circular plate-type blades and the movement of the driving motor, and the sandwich panel is cut by the upper and lower circular plate-type blades rotated at a high speed. Such a cutter has a problem that it emits severe noise due to cutting frictional sound of the upper and lower circular plate-type blades rotated at a high speed and due to large size of the cutter, the cutter is difficult to use by holding it by hands.

In Korean Utility Model Registration No. 20-0356044 titled “sandwich panel cutter” and Korean Laid-Open Patent Application No. 10-2005-94978 titled “sandwich panel cutter” for solving the above problem, effects are obtained that the structure of the cutters are relatively simple and also the noise accompanying the cutting operation is remarkably reduced compared to existing cutters. However, there are problems that since there is no power device for pushing the cutting device in the cutting operation, much labor is consumed in the case of much work load, and since the cutting device has to be moved on a guide rail, only linear cutting is possible and thus curvilinear cutting is difficult and due to provision of the guide rail etc., the cutters are long and heavy on the whole and thus inconvenient to handle.

In order to improve the problems of such conventional cutters, the applicant has previously filed Korean Registered Patent No. 10-0917125 titled “portable panel cutter”, which has been registered. As illustrated in FIGS. 1 to 3, the cutter comprises a cutting (1), a pulling means (2) for pulling the cutting blade (1) and a driving means (6) for driving the pulling means (2), wherein the cutting blade (1) comprises a upper securing part (1a), a lower heat insulating material-cutting part (1b), an opening part (1c) opened forward between the securing part and the heat insulating material-cutting part, a metal plate material-cutting blade section (1d) formed inside the opening part and a supporting part (1e) formed under the opening part, and the pulling means (2) comprises a pair of saw-toothed wheels (2a) arranged at both sides of the cutting blade and rotationally driven by the driving means (6), and the driving means (6) is constructed to transfer the driving power of a motor (8) integrally coupled with a speed reducer (7) while reducing the rotational speed of the motor.

In such a cutter of the applicant previously filed and registered, the pair of saw-toothed wheels (2a) are rotated by being driven by the motor (8) of the driving means (6) and thus the metal plate material (71) of the sandwich panel (70) is cut by the cutting blade section (1d) while the saw-toothed wheels move the metal plate material biting it.

At this time, the lower heat insulating material-cutting part (1b) of the cutting blade cuts the heat insulating material (72) of the sandwich panel (70).

As described above, the upper and lower metal plate material (71, 71) is cut by turning the sandwich panel (70) upside down.

However, the technique disclosed in the previously filed and registered patent application of the applicant has problems as follows.

First, the cutting blade section (1d) of the cutting blade (1) easily becomes blunt or is damaged in the process of repeatedly cutting the metal plate material, wherein there are problems that since the cutting blade section is integrally formed in the cutting, repair operation of sharpening an edge of the cutting blade section again is inconvenient and also it is uneconomical in that partial replacement of the cutting blade section is impossible and the entire cutting knife has to be replaced for its use.

Second, since the supporting part (1e) of the cutting blade (1) is in the horizontal form and only a simple inclined part (1f) is formed in a front inlet, in the case where concavo-convex part (75) is formed on the metal plate material (71) of the sandwich panel (70), when the cutting blade cuts the metal plate material while raised upward along the concavo-convex part (75) as illustrated in FIG. 3, a front end of the supporting part (1e) of the cutting blade is raised to be positioned above the metal plate material, so the front part of the cutting blade is caught by the metal plate material, thus cannot continuously guide the metal plate material, therefore, a problem is present that continuous cutting operation is difficult.

Third, since the driving means (6) uses the heavy and bulky motor (8) integrally coupled with the speed reducer (7), problems are present that carrying along and transporting of the cutter is inconvenient and also much inconvenience is caused to the operation at the time of the cutting operation.

### SUMMARY OF THE PRESENT INVENTION

The present invention has been devised to solve all of the problems associated with the above-described prior arts and the technique disclosed in the previously filed and registered patent application of the applicant, and its object is to provide a portable panel cutter which is far better in cost saving compared to the prior arts in which the entire cutting blade is replaced, thereby maximizing economical efficiency since the cutting blade section of the cutting blade for cutting the metal plate material is separately provided and detachably used and thus the cutting blade section can be repaired and partially replaced for its re-use at the time of wear or damage of the cutting blade section.

Another object of the present invention is to provide a portable panel cutter which exhibits excellent convenience of carrying along and transporting of the cutter and also workability at the time of the cutting operation since general-purpose electric drill detachably coupled with the speed reducer is used instead of the motor as a driving means and thus the heavy and bulky motor is not used.

Yet another object of the present invention is to provide a portable panel cutter wherein by forming a front portion of the supporting part of the cutting blade in round form, cutting operation can be continuously performed at the time of cutting the metal plate material, in particular, metal plate material of concavo-convex type, while the supporting part effectively guides the metal plate material, thereby exhibiting excellent cutting workability.

The present invention is characterized in that a portable panel cutter for cutting and tailoring a plate material such as a sandwich panel formed by overlapping a metal plate material at both side surfaces of a heat insulating material comprises a cutting blade comprising an opening part opened forward between a upper securing part and a lower heat insulating material-cutting part, a cutting blade section arranged inside the opening part for cutting the metal plate material, and a supporting part formed under the opening part for guiding the metal plate material; a pulling means for moving the metal plate material biting it by rotational driving of saw-toothed wheels arranged at both sides of the cutting blade; and a driving means for rotationally driving the saw-toothed wheels of the pulling means by shaft-coupling the wheels with a front driving shaft of a speed reducer, wherein a seat part is perforated inside the opening part of the cutting blade, and a cutting blade section is separately provided which is formed in a shape corresponding to the seat part and is formed with a front cutting edge and is detachably engaged with the seat part.

The present invention is further characterized in that at least one securing protrusion is protruded inward on the seat part of the cutting blade and a rear securing surface of the cutting blade section is closely pressed and secured in an interference fit manner by means of the securing protrusion.

The present invention is further characterized in that the supporting part of the cutting blade comprises a horizontal surface arranged inside for horizontally guiding the metal plate material, an outer inlet inclined surface and a curved surface of round form extending from the inclined surface to an end of the heat insulating material-cutting part for guiding the metal plate material.

The present invention is further characterized in that in the driving means, a general-purpose electric drill is detachably coupled to the rear of the speed reducer for driving of the drill, and a drill shaft of the electric drill is inserted and installed in a shaft groove of the speed reducer for mounting of the drill, whereby the front driving shaft of the speed reducer is rotationally driven with driving power of the electric drill.

The present invention has effects that the cutter thereof is far better in cost saving compared to the prior arts in which the entire cutting blade is replaced, thereby maximizing economical efficiency since the cutting blade section of the cutting blade for cutting the metal plate material is separately provided and detachably used and thus the cutting blade section can be repaired and partially replaced for its re-use at the time of wear or damage of the cutting blade section, and the portable panel cutter of the present invention exhibits excellent convenience of carrying along and transporting of the cutter and also workability at the time of the cutting operation since general-purpose electric drill detachably coupled with the speed reducer is used instead of the motor as a driving means and thus the heavy and bulky motor is not used.

Furthermore, the present invention has further effect that by forming a front portion of the supporting part of the cutting blade in round form, cutting operation can be continuously performed at the time of cutting the metal plate material, in particular, metal plate material of concavo-convex type, while the supporting part effectively guides the metal plate material, thereby exhibiting excellent cutting workability.

### BRIEF DESCRIPTION OF THE DRAWINGS

FIG. 1 is an exploded perspective view of a portable panel cutter disclosed in an application previously filed by the applicant.

FIGS. 2 and 3 are views illustrating a state of cutting operation of FIG. 1.

FIG. 4 is an exploded perspective view of a portable panel cutter of the present invention.

FIG. 5 is a perspective view of a cutting blade of the present invention.

FIG. 6 is a front view of the cutting blade of the present invention.

FIG. 7 is a partial enlarged view of part “A” in FIG. 6.

FIG. 8 is a perspective view illustrating a mounted state of a portable electric drill of the present invention.

FIG. 9 is a view illustrating a state of cutting operation of the present invention.

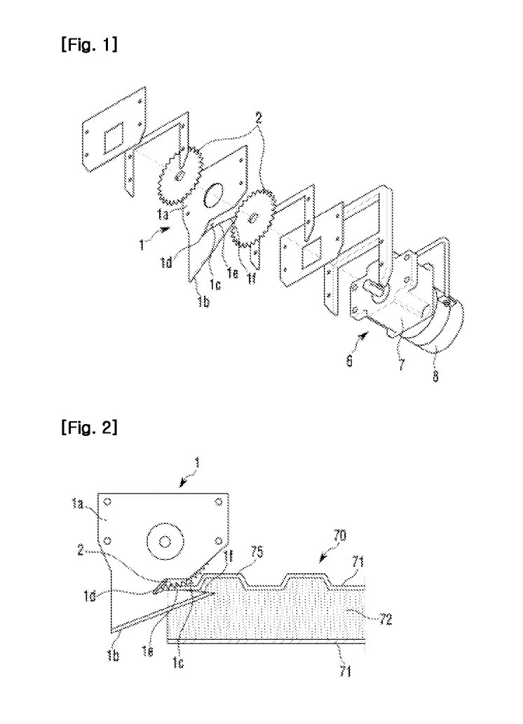

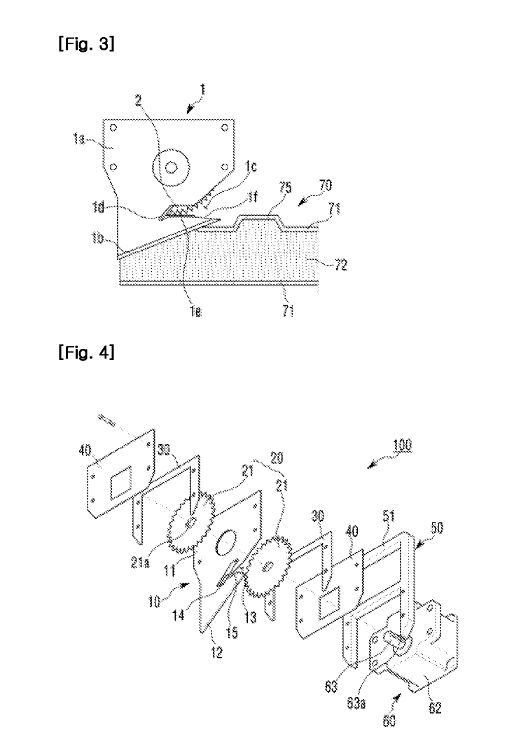

### MODE FOR CARRYING OUT THE INVENTION

Hereinafter, a preferred example of the present invention described above will be described in detail with reference to the attached drawings.

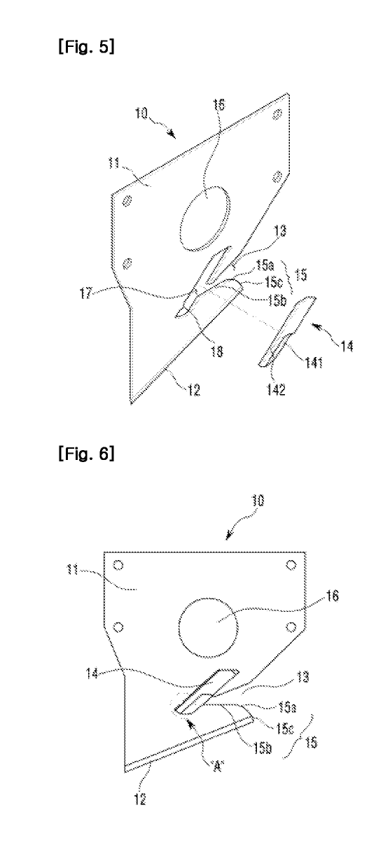

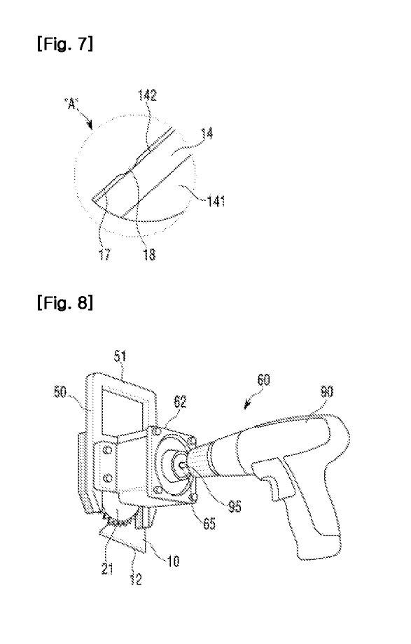

As illustrated in FIGS. 4 to 9, for cutting and tailoring a plate material such as a sandwich panel (70) which is formed by overlapping a metal plate material (71) at both side surfaces of a heat insulating material (72) such as panel for building, i.e., styrofoam, urethane foam or glass wool, the portable panel cutter (100) of the present invention comprises a cutting blade (10), a pulling means (20) for pulling the cutting blade and a driving means (60) for driving the pulling means (20).

The cutting blade (10) comprises a upper securing part (11), a lower heat insulating material-cutting part (12), an opening part (13) opened forward between the securing part (11) and the heat insulating material-cutting part (12), a cutting blade section (14) arranged inside the opening part (13) for cutting the metal plate material, and a supporting part (15) formed under the opening part for guiding the metal plate material to the cutting blade section.

In this connection, the cutting blade section (14) of the cutting blade is provided separately and detachably constructed for its detachable use.

That is to say, there are provided a seat part (17) perforated in a shape corresponding to the cutting blade section so as to seat and accommodate the cutting blade section (14) inside the opening part (13), and at least one securing protrusion (18) protruded on one side of the seat part so as to closely press and secure the cutting blade section, and the cutting blade section (14) has a shape corresponding to the seat part and is formed with a front cutting edge (141) and a rear securing surface (142) closely pressed and secured to the securing protrusion (18), and is detachably engaged with the seat part in an interference fit manner.

Also, the cutting edge (141) of the cutting blade section (14) is constructed in such a way that it is formed in an acute angle relative to a horizontal line and thus a sharp portion of the metal plate material to be cut is cut while facing the inside of the panel.

Furthermore, the supporting part (15) of the cutting blade comprises a horizontal surface (15b) arranged inside for horizontally guiding the metal plate material (70), an outer inlet inclined surface (15a) and a curved surface (15c) of round form extending from the inclined surface to an end of the heat insulating material-cutting part (12) for introducing and guiding the metal plate material (70).

Furthermore, the pulling means (20) comprises a pair of saw-toothed wheels (21, 21) rotationally driven by being shaft-coupled with a front driving shaft (63) of a speed reducer (62) of the driving means (60). The pair of saw-toothed wheels (21, 21) are installed in such a way that they are positioned above the supporting part (15) on both sides of the cutting blade and a lower end of tooth (21a) of the saw-toothed wheels is at least positioned below the supporting part (15), thus the saw-toothed wheels pull the metal plate material biting and moving it while rotationally driven.

Also, the saw-toothed wheels (21,21) are encompassed and protected by a pair of spacers (30) and a pair of covers (40), and the cutting blade (10), spacers (30) and covers (40) are fixedly installed together with a bracket (50) on the speed reducer (62) of the driving means (60) by fastening members.

Furthermore, the bracket (50) is provided with a separate handle (51) for facilitating the handling of the panel cutter of the present invention.

Furthermore, in the driving means (60), a general-purpose electric drill (90) is detachably coupled to the rear of the speed reducer (62) for driving of the drill, and a drill shaft (95) of the electric drill (90) is inserted and installed in a shaft groove (65) of the speed reducer (62) for mounting of the drill, whereby the front driving shaft (63) of the speed reducer is rotated with speed reduction thereof by driving power of the electric drill and thus the pulling means (20) is driven.

In this connection, the speed reducer (62) has a common structure, and the driving power of the pulling means (20) is adjusted by adjusting gear ratio of an internal reduction gear.

Furthermore, in the present invention, although not illustrated in the drawings, a circular plate having a shaft hole is coupled with a circular plate hole (16) formed at the center of cutting blade (10), and the front driving shaft (63) of the speed reducer is rotated while inserted in the shaft hole, therefore, the driving shaft is supported so as to prevent a damage due to the rotation of the driving shaft of the speed reducer.

As a reference sign not yet described, “63a” designates a key groove formed for key-coupling shaft holes (21a) of the saw-toothed wheels of the pulling means to the front driving shaft of the speed reducer.

Next, operation and action of the present invention as constructed above will be described.

First, in the present invention, the electric drill (90) is mounted by inserting the drill shaft (95) of the electric drill in the rear shaft groove (65) of the speed reducer (62).

In such a state, if the electric drill (90) is operated, rotational driving power of the electric drill drives the front driving shaft (63) while the rotational speed is reduced by the speed reducer (62), thereby rotating the saw-toothed wheels (21, 21) of the pulling means.

In such a state, the sandwich panel (70) is cut and tailored.

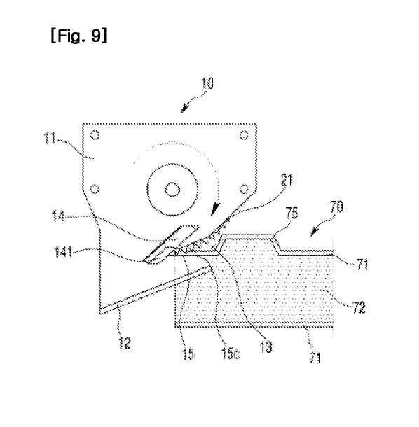

That is to say, teeth (21a) of the saw-toothed wheels move the upper metal plate material (71) of the sandwich panel biting it while the saw-toothed wheels (21, 21) of the pulling means is rotated in a direction of an arrow illustrated in FIG. 9.

The upper metal plate material (71) of the sandwich panel pulled by the saw-toothed wheels (21, 21) of the pulling means as described above is inserted into the opening part (13) while guided by the supporting part (15) of the cutting blade (10), and then is cut by the front cutting edge (141) of the cutting blade section (14) inside the opening part.

In particular, in the case where concavo-convex part (75) is formed on the metal plate material (71) of the sandwich panel, the cutting blade (10) cuts the metal plate material while raised along the concavo-convex part, wherein since the supporting part (15) of the cutting blade has the curved surface (15c) of round form extending from the outer inlet inclined surface (15a) to an end of the heat insulating material-cutting part (12), the cutting blade (10) continuously introduces and guides the metal plate material (71) even in a raised position, thus can continuously perform the cutting operation, while the front portion of the supporting part (15) is positioned below the metal plate material.

That is to say, since the concavo-convex part (75) formed on the metal plate material (71) of the sandwich panel can be continuously introduced and guided by the supporting part (15) of the cutting blade, the cutting operation by the cutting blade section (14) can be continuously performed.

In such a way, the metal plate material (71) of the sandwich panel is cut by the cutting blade section (14) of the cutting blade and at the same time the heat insulating material (72) of the sandwich panel is cut by the lower heat insulating material-cutting part (12) of the cutting blade (10).

By doing so, if the upper metal plate material (71) of the sandwich panel is completely cut, the sandwich panel (70) is turned upside down and then the lower metal plate material (71) is again cut and tailored by the cutting blade (10) in the same way as described above.

Meanwhile, in the present invention, if the cutting edge (141) of the cutting blade section has become blunt or been damaged in the process of repeatedly cutting the metal plate material of the sandwich panel by the cutting blade section (14) of the cutting blade (10), the cutting blade section (14) is forcedly separated from the seat part (17) of the cutting blade and then repaired or partially replaced for its re-use.

In this connection, the cutting blade section (14) repaired and partially replaced is mounted again in the seat part (17) of the cutting blade (10) in the interference fit, wherein for assembling and using of the cutting blade section, the securing protrusion (18) on one side of the seat part is secured to the rear securing surface (142) of the cutting blade section while being in close contact therewith, thereby establishing the interference fit.

Thus, in the present invention, since the general-purpose electric drill mounted to the speed reducer is used instead of the motor as a driving means, the cutter of the present invention is more conveniently portable, and due to separate provision of the cutting blade section of the cutting blade, the cutting blade section can be repaired and partially replaced for its re-use at the time of wear or damage thereof in the process of cutting the metal plate material such as the sandwich panel, and due to improvement of the structure of the supporting part of the cutting blade, the metal plate material can be effectively guided and thus continuous cutting operation is possible.

What is claimed:

1. A portable panel cutter for cutting and tailoring a plate material such as a sandwich panel formed by overlapping a metal plate material at both side surfaces of a heat insulating material, the cutter comprising:
a cutting blade (10) comprising an opening part (13) opened forward between a upper securing part (11) and a lower heat insulating material-cutting part (12), a cutting blade section arranged inside the opening part for cutting the metal plate material, and a supporting part (15) formed under the opening part for guiding the metal plate material;
a pulling means (20) for moving the metal plate material biting it by rotational driving of saw-toothed wheels (21, 21) arranged at both sides of the cutting blade; and
a driving means (60) for rotationally driving the saw-toothed wheels of the pulling means by shaft-coupling the wheels with a front driving shaft (63) of a speed reducer (62),
wherein a seat part (17) is perforated inside the opening part (13) of the cutting blade (10), and a cutting blade section (14) is separately provided which is formed in a shape corresponding to the seat part and is formed with a front cutting edge (141) and is detachably engaged with the seat part.

2. The portable panel cutter according to claim 1, wherein at least one securing protrusion (18) is protruded inward on the seat part (17) of the cutting blade and a rear securing surface (142) of the cutting blade section (14) is closely pressed and secured in an interference fit manner by means of the securing protrusion.

3. The portable panel cutter according to claim 1, wherein the supporting part (15) of the cutting blade comprises a horizontal surface (15b) arranged inside for horizontally guiding the metal plate material (70), an outer inlet inclined surface (15a) and a curved surface (15c) of round form extending from the inclined surface to an end of the heat insulating material-cutting part (12) for guiding the metal plate material (70).

4. The portable panel cutter according to claim 1, wherein in the driving means (60), a general-purpose electric drill (90) is detachably coupled to the rear of the speed reducer (62) for driving of the drill, and a drill shaft (95) of the electric drill (90) is inserted and installed in a shaft groove (65) of the speed reducer (62) for mounting of the drill, whereby the front driving shaft (63) of the speed reducer is rotationally driven with driving power of the electric drill.
